(19) United States
(12) Patent Application Publication
(10) Pub. No.: US 2026/0347969 A1
(43) Pub. Date: Nov. 5, 2026

(54) METHOD FOR MANUFACTURING AN ALUMINUM ALLOY PART

(71) Applicant: C-TEC CONSTELLIUM TECHNOLOGY CENTER, VOREPPE (FR)

(72) Inventor: Bechir CHEHAB, Voiron (FR)

(21) Appl. No.: 19/099,287

(22) PCT Filed: Aug. 18, 2023
(86) PCT No.: PCT/FR2023/051279

§ 371 Date: Jan. 28, 2025

(30) Foreign Application Priority Data
Aug. 25, 2022 (FR) FR2208540

(51) Int. Cl. C22C 21/00; B22F 10/28; B22F 10/64; B33Y 10/00; B33Y 40/20; B33Y 70/00

(52) U.S. Cl. CPC C22C 21/00; B22F 10/28; B22F 10/64; B33Y 10/00; B33Y 40/20; B33Y 70/00; B22F 2301/052; B22F 2998/10; B22F 2999/00

(57) ABSTRACT

A method for manufacturing a part (20) including forming successive metal layers (20₁ . . . 20ₙ), superposed on top of one another, each layer being formed by deposition of a filler metal (15, 25), the filler metal being subjected to an energy input so as to melt down and form, when solidifying, said layer, the method being characterized in that the filler metal (15, 25) is an aluminum alloy including the following alloying elements (% by weight):
at least one alloying element selected from: Zr, Hf, and Er, according to a mass fraction higher than or equal to 0.30 each and in total;
at least one alloying element selected from: Cr, V, Ti and Mn, according to a mass fraction higher than 0.50% each and in total;
Fe, according to a mass fraction of 0.10 to 2.50%;
optionally Co, La, Ce, mischmetal, W, Ta, Mo, Nb, Ni, Cu, Ag, Si, Sc, Mg, Zn, Li, Nd, Y, Tm, Lu, Yb, Sr, Ba, Sb, Bi, Ca, P, B, In, Sn and impurities;
   the remainder being aluminum.

### TECHNICAL FIELD

The technical field of the invention relates to a method for manufacturing a part made of an aluminum alloy, implementing an additive manufacturing technique.

### PRIOR ART

Additive manufacturing techniques have been developed since the 80s. These consist in shaping a part by material addition, which is in contrast with machining techniques, which aim to remove the material. Formerly restricted to prototyping, additive manufacturing is now operational for manufacturing industrial products in mass production, including metal parts.

The term “additive manufacturing” is defined according to the French standard XP E67-001 as a “set of processes allowing manufacturing, layer-by-layer, by material addition, a physical object based on a digital object”. The standard ASTM F2792 (January 2012) also defines additive manufacturing. Different additive manufacturing approaches are also defined and described in the standard ISO/ASTM 17296-1. Resorting to additive manufacture to make an aluminum part, with a low porosity, has been described in document WO2015006447. In general, the application of successive layers is carried out by application of a so-called filler material, and then melting or sintering the filler material using an energy source such as a laser beam, an electron beam, a plasma torch or an electric arc. Irrespective of the additive manufacturing approach that is applied, the thickness of each added layer is in the range of a few tens or hundreds of microns.

Other additive manufacturing methods can be used. For example, and without limitation, mention may be made of melting or sintering of a filler material in the form of a powder. This may consist of laser melting or sintering. Patent application US20170016096 describes a method for manufacturing a part by localized melting obtained by exposing a powder to an energy beam such as an electron beam or a laser beam, the method being also referred to by the English acronym LPBF, meaning “Laser Powder Bed Fusion” or “Electron Beam Melting”.

The mechanical properties of the aluminum parts obtained by additive manufacturing depend on the alloy forming the filler metal, and more specifically on its composition as well as on the heat treatments applied following the implementation of the additive manufacture.

The Applicant has determined an alloy composition which, when used in an additive manufacturing process, allows obtaining parts with remarkable mechanical performances, yet without it being necessary to implement heat treatments such as a solution heat treatment and a quenching.

For aluminum alloys, the maximum electrical or thermal conductivity is generally obtained for pure aluminum. However, pure aluminum suffers from low mechanical properties, which limits the field of use thereof. To improve the mechanical strength of pure aluminum, it is possible to increase its contents in added elements. Conversely, to improve the electrical conductivity of an aluminum alloy, it is possible to limit the contents in added elements other than aluminum. Thus, the variation in the total content in added elements impacts, in an antinomic manner, the conductivity and the mechanical strength of an aluminum alloy. Also, it is difficult to design aluminum alloys having a sufficient thermal conductivity in the manufacturing raw state as well as a sufficient mechanical strength after heat treatment.

According to a variant of the present invention, through an appropriate selection of the added elements, the Applicant has identified compositions of aluminum alloys intended for additive manufacturing processes, in particular LPBF, these compositions allow obtaining a very good processability of the parts in the LPBF process as well as excellent mechanical performances of the parts in service. The good processability of the parts in the LPBF process is obtained by combining in the manufacturing raw state, a sufficiently low hardness level (for example Knoop hardness HK0.05 in the manufacturing raw state lower than 140, preferably lower than 130, preferably lower than 120) and a sufficiently high thermal or electrical conductivity (for example electrical conductivity in the manufacturing raw state higher than 6 MS/m, preferably higher than 7 MS/m, preferably higher than 8 MS/m). This hardness and conductivity combination allows limiting the level of residual stresses of the parts in the manufacturing raw state, which significantly limits the risks of cracking, delamination or distortion, thereby significantly improving the processability of the parts in the LPBF process. Excellent mechanical performances of the parts in service are obtained by maximizing the hardness of the parts after post-manufacture heat treatment (for example Knoop hardness HK0.05 higher than 70, preferably higher than 80, preferably higher than 90, preferably higher than 100, preferably higher than 114).

Pure aluminum powders may be used as a reducing agent in the solid propellant of aerospace thrusters. Consequently, aluminum powders with more than 97% aluminum are generally considered in some countries as dual-use goods (DUG) requiring export licenses. This classification represents a constraint that might slow down the commercialization of some aluminum powders comprising more than 97% aluminum intended for the additive manufacturing process like, for example, LPBF. Thus, it seems to be advantageous that the developed solution has less than 97% of aluminum, i.e. more than 3% added elements in total.

According to another variant of the present invention, through an appropriate selection of the added elements, the Applicant has identified compositions of aluminum alloys intended for additive manufacturing processes, in particular LPBF, these compositions including more than 3% of added elements in total and allowing for a good processability of the parts in the LPBF process, while maximizing the mechanical performances of the parts in service.

### DISCLOSURE OF THE INVENTION

A first object of the invention is a method for manufacturing a part including forming successive metal layers, superposed on top of one another, each layer being formed by the deposition of a filler metal, the filler metal being subjected to an energy input so as to melt down and form, when solidifying, said layer, the method being characterized in that the filler metal is an aluminum alloy including the following alloying elements in weight percents:
at least one alloying element selected from: Zr, Hf, and Er, according to a mass fraction higher than or equal to 0.30%, preferably from 0.30 to 2.50%, preferably from 0.40 to 2.00%, more preferably from 0.40 to 1.80%, even more preferably from 0.50 to 1.60%, even more preferably from 0.60 to 1.50%, even more preferably from 0.70 to 1.40%, even more preferably from 0.80 to 1.30% each and in total;
at least one alloying element selected from: Cr, V, Ti and Mn, according to a mass fraction higher than 0.50%, preferably from more than 0.50 to 6.00%, preferably from 1.00 to 6.00%, preferably from 1.00 to 5.00%, more preferably from 1.00 to 4.00%, even more preferably from 1.00 to 3.00%, each for V, Ti and Mn, and in total; and according to a mass fraction from more than 0.50 to 3.00% for Cr;
optionally at least one alloying element selected from: Co, La, Ce, mischmetal, W, Ta, Mo and Nb, according to a mass fraction of at least 0.10%, preferably at least 0.25%, more preferably at least 0.50% each and in total; and according to a mass fraction lower than 5.00%, preferably lower than 4.00%, preferably lower than 3.00% each; and according to a mass fraction lower than 7.00%, preferably lower than 6.00%, preferably lower than 5, 00%, preferably lower than 4.00% in total;
Fe, according to a mass fraction of 0.10 to 2.50%, preferably from 0.15 to 2.50%, preferably from 0.20 to 2.50%, more preferably from 0.30 to 2.50%, even more preferably from 0.50 to 2.50%, even more preferably from 0.75 to 2.25%;
optionally Ni, according to a mass fraction lower than 3.00%, preferably lower than 2.00%, preferably lower than 1.00%, preferably lower than 0.50%;
optionally at least one alloying element selected from: Cu and Ag, according to a mass fraction of 0.10 to 3.00%, preferably from 0.10 to 2.00%, preferably from 0.10 to 1.60%, preferably from 0.10 to 1.00%, preferably from 0.10 to 0.70% each and in total;
optionally Si, according to a mass fraction lower than 3.00%, preferably lower than 2.00%, preferably lower than 1.00%, preferably lower than 0.50%; in one embodiment, the Si content is lower than 0.30%, preferably lower than 0.20%;
optionally Sc, according to a mass fraction lower than 0.80%, preferably lower than 0.70%, preferably lower than 0.60%, preferably lower than 0.50%, preferably lower than 0.40%, preferably lower than 0.30%;
optionally Mg, according to a mass fraction lower than 2.00%, preferably lower than 1.00%, preferably lower than 0.50%, more preferably lower than 0.30%;
optionally Zn, according to a mass fraction lower than 2.00%, preferably lower than 1.00%, preferably lower than 0.50%, more preferably lower than 0.30%;
optionally Li, according to a mass fraction lower than 2.00%, preferably lower than 1.00%, preferably lower than 0.50%, more preferably lower than 0.30%;
optionally at least one element selected from: Nd, Y, Tm, Lu, Yb, Sr, Ba, Sb, Bi, Ca, P, B, In and Sn, according to a mass fraction lower than or equal to 1.00%, preferably lower than or equal to 0.50%, preferably lower than or equal to 0.30%, more preferably lower than or equal to 0.10%, even more preferably lower than or equal to 700 ppm each, and lower than or equal to 2.00%, preferably lower than or equal to 1.00%, preferably lower than or equal to 0.50%, preferably lower than or equal to 0.30% in total;
impurities: <0.05% each, and preferably <0.15% in total;
   the remainder being aluminum.

In particular, each layer may describe a pattern defined from a digital model.

According to one embodiment, the filler metal is in the form of a powder, the exposure of which to a beam of light or of charged particles, results in a local meltdown followed by a solidification, so as to form a solid layer. According to another embodiment, the filler metal originates from a filler wire, the exposure of which to a heat source, for example an electric arc, results in a local meltdown followed by a solidification, so as to form a solid layer.

A second object of the invention is a metal part, obtained by a method according to the first or second object of the invention.

A third object of the invention is a filler material, in particular a filler wire or a powder, intended to be used as a filler material of an additive manufacturing process, characterized in that it consists of an aluminum alloy, including the following alloying elements (% by weight):
at least one alloying element selected from: Zr, Hf, and Er, according to a mass fraction higher than or equal to 0.30%, preferably from 0.30 to 2.50%, preferably from 0.40 to 2.00%, more preferably from 0.40 to 1.80%, even more preferably from 0.50 to 1.60%, even more preferably from 0.60 to 1.50%, even more preferably from 0.70 to 1.40%, even more preferably from 0.80 to 1.30% each and in total;
at least one alloying element selected from: Cr, V, Ti and Mn, according to a mass fraction higher than 0.50%, preferably from more than 0.50 to 6.00%, preferably from 1.00 to 6.00%, preferably from 1.00 to 5.00%, more preferably from 1.00 to 4.00%, even more preferably from 1.00 to 3.00%, each for V, Ti and Mn, and in total; and according to a mass fraction from more than 0.50 to 3.00% for Cr;
optionally at least one alloying element selected from: Co, La, Ce, mischmetal, W, Ta, Mo and Nb, according to a mass fraction of at least 0.10%, preferably at least 0.25%, more preferably at least 0.50% each and in total; and according to a mass fraction lower than 5.00%, preferably lower than 4.00%, preferably lower than 3.00% each; and according to a mass fraction lower than 7.00%, preferably lower than 6.00%, preferably lower than 5, 00%, preferably lower than 4.00% in total;
Fe, according to a mass fraction of 0.10 to 2.50%, preferably from 0.15 to 2.50%, preferably from 0.20 to 2.50%, more preferably from 0.30 to 2.50%, even more preferably from 0.50 to 2.50%, even more preferably from 0.75 to 2.25%;
optionally Ni, according to a mass fraction lower than 3.00%, preferably lower than 2.00%, preferably lower than 1.00%, preferably lower than 0.50%;
optionally at least one alloying element selected from: Cu and Ag, according to a mass fraction of 0.10 to 3.00%, preferably from 0.10 to 2.00%, preferably from 0.10 to 1.60%, preferably from 0.10 to 1.00%, preferably from 0.10 to 0.70% each and in total;
optionally Si, according to a mass fraction lower than 3.00%, preferably lower than 2.00%, preferably lower than 1.00%, preferably lower than 0.50%; in one embodiment, the Si content is lower than 0.30%, preferably lower than 0.20%;
optionally Sc, according to a mass fraction lower than 0.80%, preferably lower than 0.70%, preferably lower than 0.60%, preferably lower than 0.50%, preferably lower than 0.40%, preferably lower than 0.30%;
optionally Mg, according to a mass fraction lower than 2.00%, preferably lower than 1.00%, preferably lower than 0.50%, more preferably lower than 0.30%;
optionally Zn, according to a mass fraction lower than 2.00%, preferably lower than 1.00%, preferably lower than 0.50%, more preferably lower than 0.30%;
optionally Li, according to a mass fraction lower than 2.00%, preferably lower than 1.00%, preferably lower than 0.50%, more preferably lower than 0.30%;
optionally at least one element selected from: Nd, Y, Tm, Lu, Yb, Sr, Ba, Sb, Bi, Ca, P, B, In and Sn, according to a mass fraction lower than or equal to 1.00%, preferably lower than or equal to 0.50%, preferably lower than or equal to 0.30%, more preferably lower than or equal to 0.10%, even more preferably lower than or equal to 700 ppm each, and lower than or equal to 2.00%, preferably lower than or equal to 1.00%, preferably lower than or equal to 0.50%, preferably lower than or equal to 0.30% in total;
impurities: <0.05% each, and <0.15% in total;
   the remainder being aluminum.

The aluminum alloy forming the filler material may have the characteristics described in connection with the first object of the invention.

The filler material may be in the form of a powder. The powder may be such that at least 80% of the particles composing the powder have an average size in the following range: 5 μm to 200 μm, preferably from 5 to 150 μm, preferably from 5 to 25 μm, or from 20 to 60 μm or from 20 to 80 μm or from 20 to 90 μm or from 20 to 100 μm or from 20 to 110 μm or from 20 to 120 μm. In the case where the filler material is in the form of a wire, the diameter of the wire may in particular be comprised between 0.5 mm and 3 mm, and preferably comprised between 0.5 mm and 2 mm, and more preferably comprised between 1 mm and 2 mm.

A fourth object of the invention is the use of a powder or a filler wire as described hereinbefore and in the remainder of the description in a manufacturing process selected from: electron beam melting, cold spray consolidation, laser metal deposition, additive friction stir, field-assisted sintering or inertia rotary friction welding, preferably cold spray consolidation.

Other advantages and features will appear more clearly from the following description of particular embodiments of the invention, provided as non-limiting examples, and shown in the figures listed hereinbelow.

### FIGURES

FIG. 1 is a diagram illustrating an LPBF-type additive manufacturing process.

FIG. 2 is a diagram illustrating a WAAM-type additive manufacturing process.

FIG. 3 is a diagram of the strip after laser reflow used according to the examples.

FIG. 4 is a diagram of the Knoop hardness measurement test.

### DISCLOSURE OF PARTICULAR EMBODIMENTS

Unless stated otherwise, in the description:
the designation of the aluminum alloys is in compliance with the nomenclature of The Aluminum Association;
the chemical element contents are reported in % and represent mass fractions. The notation x %-y % means higher than or equal to x % and lower than or equal to y %.

By impurities, it should be understood chemical elements that are unintentionally present in the alloy.

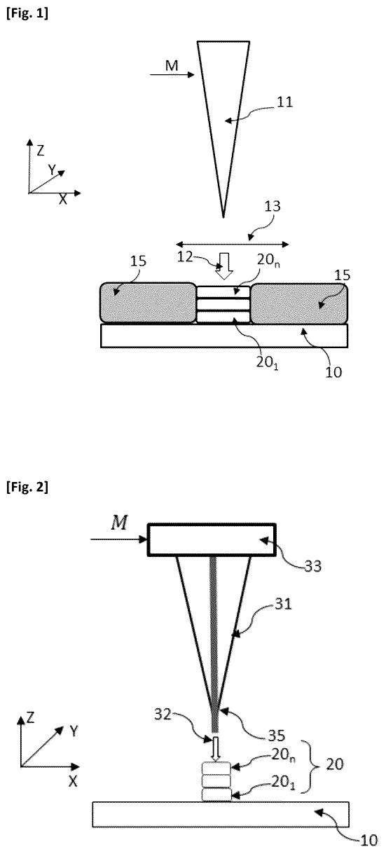

FIG. 1 schematizes the operation of an additive manufacturing process of the selective laser melting type (Laser Powder Bed Fusion or LPBF). The filler metal 15 is in the form of a powder disposed over a support 10. An energy source, in this case a laser source 11, emits a laser beam 12. The laser source is coupled to the filler material by an optical system 13, whose movement is determined according to a digital model M. The laser beam 12 propagates according to an axis of propagation Z, and follows a movement according to a plane XY, describing a pattern dependent on the digital model M. For example, the plane is perpendicular to the axis of propagation Z. The interaction of the laser beam 12 with the powder 15 causes a selective fusion of the latter, followed by a solidification, resulting in the formation of a layer 20₁ . . . 20ₙ. When a layer has been formed, it is covered with powder 15 of the filler metal and another layer is formed, superposed with the layer made before. For example, the thickness of a layer may be comprised from 10 h 250 μm, for example 30 μm, or 60 μm, or 80 μm, or 90 μm, or 100 μm, or 110 μm, or 120 μm, or 130 μm, or 140 μm, or 150 μm, or 160 μm, or 170 μm, or 180 μm, or 190 μm, or 200 μm.

An increase in the layer thickness may be beneficial to increase productivity during printing and to limit sensitivity to thermal cracking related to residual stresses during manufacture of the part and/or during a post-manufacture heat treatment. An increase in the layer thickness may be accompanied by an adaptation of the power of the laser and of the vector difference (distance between two successive laser passes) and the scanning speed of the laser in order to ensure a complete meltdown of each powder layer under optimum conditions. For example, the layer thickness may be comprised between 60 and 250 μm, preferably from 80 to 200 μm, preferably from 90 to 180 μm, preferably from 100 to 180 μm, preferably from 110 to 170 μm, preferably from 120 to 160 μm.

For aluminum alloys, the support 10 or tray may be heated to a preheating temperature T ranging up to 500 °C. In general, the machines currently available on the market offer heating of the tray up to 200 °C. For example, the heating temperature of the tray (=preheating temperature T) may be about 50 °C, 100 °C, 150 °C, 200 °C, 250 °C, 300 °C or 350 °C or 400 °C or 450 °C or 500 °C. In general, heating the tray allows reducing humidity in the powder bed and also reducing the residual stresses on the parts during manufacture. The humidity level at the level of the powder bed seems to have a direct effect on the porosity of the final part. Indeed, it seems that the higher the humidity of the powder, the higher the porosity of the final part will be. It should be noted that heating the tray is one of the existing possibilities for carrying out hot additive manufacturing. However, the present invention could not be limited to the use of only this heating means. All of the other heating means, allowing carrying out this preheating step, can be used in the context of the present invention to heat and control the temperature, for example an infrared lamp. Thus, the method according to the present invention may be carried out at a preheating temperature T ranging up to 500 °C.

For some compositions, the Inventors have noticed that when the preheating temperature T is lower than or equal to 160 °C and higher than or equal to 25 °C, the parts have a better resistance to thermal cracking related to residual stresses. Preferably, preheating the tray and therefore the powder bed may be performed at a preheating temperature T lower than or equal to 140 °C, or, better still, lower than or equal to 130 °C. The preheating temperature T is higher than room temperature. The preferred ranges of the preheating temperature T are: 25 °C≤T≤160 °C, preferably 30 °C≤T≤150 °C, preferably 50 °C≤T≤150 °C, preferably 50 °C≤T≤140 °C, preferably 60 °C≤T≤140 °C, preferably 70 °C≤T≤135 °C, preferably 80 °C≤T≤130 °C.

According to one alternative, the preheating temperature T corresponds to the conditions under which an effective expansion could be obtained. The preheating temperature range T may then be comprised between 300 °C and 500 °C, preferably from 300 to 400 °C, preferably from 300 to 350 °C. It is considered that, at this preheating temperature range T, the manufacturing conditions of the part generate less residual stresses. According to this alternative, an expansion post-manufacture heat treatment, as described hereinafter in the present description, is also relevant.

The powder according to the present invention may have at least one of the following characteristics:
Average particle size from 5 μm to 200 μm, preferably from 5 to 150 μm, preferably from 5 to 25 μm, or from 20 to 60 μm, or from 20 to 80 μm, or from 20 to 90 μm, or from 20 to 100 μm, or from 20 to 110 μm, or from 20 to 120 μm. The data values mean that at least 80% of the particles have an average size within the specified range.
Spherical shape. For example, the sphericity of a powder may be determined using a morphogranulometer.
Good castability. For example, the castability of a powder may be determined according to the standard ASTM B213 or the standard ISO 4490:2018. According to the standard ISO 4490:2018, the flow time is preferably shorter than 50.
Low porosity, preferably from 0 to 5%, more preferably from 0 to 2%, still more preferably from 0 to 1% by volume. In particular, the porosity may be determined by analysis of images from optical micrographs or by helium pycnometry (cf. the standard ASTM B923).
Absence or small amount (lower than 10%, preferably lower than 5% by volume) of small particles (1 to 20% of the average size of the powder), so-called satellites, which stick to the larger particles.

The implementation of such a method allows manufacturing parts at a high yield, which could reach and even exceed 200 cm³/h by laser.

Moreover, the Applicant has observed that the application of post-manufacture heat treatments such as quenching could induce a distortion of the part, because of the brutal temperature variation. In general, the distortion of the part is even more significant as its dimensions are large. Yet, the advantage of an additive manufacturing process is specifically to obtain a part whose shape, after manufacture, is permanent, or quasi-permanent. Hence, the occurrence of a significant deformation resulting from a post-manufacture heat treatment should be avoided. By quasi-permanent, it should be understood that a finish machining could be performed on the part after manufacture thereof: the part manufactured by additive manufacturing extends according to its final shape, within the finish machining margins.

Having noticed the foregoing, the Applicant has sought an alloy composition, forming the filler material, allowing obtaining mechanical and electrical or thermal conductivity properties that are acceptable, without the need for the application of heat treatments, following the formation of the layers, i.e. following the formation of the final part, which might induce a distortion. In particular, the aim is to avoid heat treatments involving an abrupt variation in the temperature. Thus, the invention allows obtaining, by additive manufacturing, a part whose mechanical properties, in particular in terms of yield strength, and electrical or thermal conductivity, are satisfactory. Depending on the selected type of additive manufacturing process, the filler material may be in the form of a wire or a powder.

The following elements may be used in the aluminum alloy.

Zr, Hf and/or Er:

According to the present invention, at least one alloying element selected from: Zr, Hf and Er is present in the aluminum alloy according to a mass fraction higher than or equal to 0.30%, preferably from 0.30 to 2.50%, preferably from 0.40 to 2.00%, more preferably from 0.40 to 1.80%, even more preferably from 0.50 to 1.60%, even more preferably from 0.60 to 1.50%, even more preferably from 0.70 to 1.40%, even more preferably from 0.80 to 1.30% each and in total. Preferably, the mass fraction of at least one alloying element selected from: Zr, Hf and Er is higher than or equal to 0.30%, or 0.35%, or 0.40%, or 0.45%, or 0.50%, or 0.55%, or 0.60%, or 0.65%, or 0.70% each and in total. Preferably, the mass fraction of at least one alloying element selected from: Zr, Hf and Er is lower than or equal to 2.50%, or 2.40%, or 2.30%, or 2.20%, or 2.10%, or 2.00%, or 1.90%, or 1.80%, or 1.70%, or 1.60%, or 1.50%, or 1.40%, or 1.30% each and in total.

These elements have a high solubility in the manufacturing raw state. Thus, their addition could significantly lower conductivity in the raw state. However, the addition of a post-manufacture heat treatment, for example at a temperature comprised between 300 and 450 °C, for durations of 0.5 to 10 hours, could allow significantly lowering their contents in solid solution by formation of Al3X-type hardening dispersoids (X=Zr or Hf or Er). The formation of these dispersoids during the heat treatment could allow simultaneously increasing the hardness and the electrical conductivity with respect to the raw state.

These elements could also allow controlling the granular structure during laser melting by promoting the apparition of equiaxed grains.

Moreover, the presence of at least one alloying element selected from: Zr, Hf and Er in the alloy could confer a good processability on the alloy, the term processability corresponding to the English designation “processability”, referring to the ability of an alloy to be shaped by an additive manufacturing process. This could be reflected, at the level of a part manufactured by additive manufacturing, by a quasi-absence of cracking-type defects, and a low porosity.

Cr, V, Ti and/or Mn:

According to the present invention, at least one alloying element selected from: Cr, V, Ti and Mn is present in the aluminum alloy according to a mass fraction higher than 0.50%, preferably from more than 0.50 to 6.00%, preferably from 1.00 to 6.00%, more preferably from 1.00 to 5.00%, even more preferably from 1.00 to 4.00%, even more preferably from 1.00 to 3.00%, each for V, Ti and Mn, and in total; and according to a mass fraction from more than 0.50 to 3.00% for Cr. Preferably, the mass fraction of at least one alloying element selected from: Cr, V, Ti and Mn is higher than 0.50%, or higher than or equal to 0.60%, or 0.70%, or 0.80%, or 0.90%, 1.00% each and in total. Preferably, the mass fraction of at least one alloying element selected from: Cr, V, Ti and Mn is lower than or equal to 6.00%, or 5.50%, or 5.00%, or 4.50%, or 4.00%, or 3.50%, or 3.00%, or 2.50%, or 2.00%, or 1.50%, or 1.00% each and in total.

These elements could allow increasing the mechanical strength of the alloy by solid solution and/or by dispersoids which might form during the manufacture of the part or during post-manufacture heat treatments. Yet, these elements have a high solubility in aluminum and have a negative impact on the conductivity. The addition of these elements is interesting for alloys intended for some applications requiring no particular performances in terms of electrical or thermal conductivity but which require a high mechanical strength, like structural parts, hydraulic blocks, etc.

Co, La, Ce, Mischmetal, W, Ta, Mo and/or Nb:

According to the present invention, at least one alloying element selected from: Co, La, Ce, mischmetal, W, Ta, Mo and/or Nb may be present in the aluminum alloy according to a mass fraction of at least 0.10%, preferably at least 0.25%, more preferably at least 0.50% each and in total; and according to a mass fraction lower than 5.00%, preferably lower than 4.00%, preferably lower than 3.00% each; and according to a mass fraction lower than 7.00%, preferably lower than 6.00%, preferably lower than 5.00%, preferably lower than 4.00% in total. Preferably, the mass fraction of at least one alloying element selected from: Co, La, Ce, mischmetal, W, Ta, Mo and Nb is higher than or equal to 0.10%, or 0.15%, or 0.20%, or 0.25%, or 0.30%, or 0.35%, or 0.40%, or 0.45%, or 0.50% each and in total. Preferably, the mass fraction of at least one alloying element selected from: Co, La, Ce, mischmetal, W, Ta, Mo and Nb is lower than 5.00%, or 4.50%, or 4.00%, or 3.50%, or 3.00% each. Preferably, the mass fraction of at least one alloying element selected from: Co, La, Ce, mischmetal, W, Ta, Mo and Nb is lower than 7.00%, or 6.50%, or 6.00%, or 5.50%, or 5.00%, or 4.50%, or 4.00% in total.

These elements could allow increasing the mechanical strength of the alloy by solid solution and/or by dispersoids which might form during the manufacture of the part or during post-manufacture heat treatments. These elements have a low solubility in aluminum. The addition of these elements could allow hardening the alloy without having a significant negative impact on conductivity.

Preferably, the aluminum alloy comprises at least one alloying element selected from Co, La, Ce, mischmetal, W, Ta, Mo and Nb.

### Fe:

According to the present invention, the element Fe is present in the aluminum alloy according to a mass fraction of 0.10 to 2.50%, preferably from 0.15 to 2.50%, preferably from 0.20 to 2.50%, more preferably from 0.20 to 2.50%, even more preferably from 0.30 to 2.50%, even more preferably from 0.50 to 2.50%, even more preferably from 0.75 to 2.25%. Preferably, the mass fraction of Fe is higher than or equal to 0.10%, or 0.15%, or 0.20%, or 0.25%, or 0.30%, or 0.35%, or 0.40%, or 0.45%, or 0.50%, or 0.55%, or 0.60%, or 0.65%, or 0.70%, or 0.75%. Preferably, the mass fraction of Fe is lower than or equal to 2.50%, or 2.40%, or 2.30%, or 2.20%, or 2.25%.

This element could allow increasing the mechanical strength of the alloy by solid solution and/or by dispersoids which might form during the manufacture of the part or during post-manufacture heat treatments. This element has a low solubility in aluminum. The addition of this element could allow hardening the alloy without having a significant negative impact on conductivity.

### Ni:

According to the present invention, the element Ni may be present in the aluminum alloy according to a mass fraction lower than 3.00%, preferably lower than 2.00%, preferably lower than 1.00%, preferably lower than 0.50%. Preferably, the mass fraction of Ni is higher than 500 ppm, preferably higher than 0.10%, preferably higher than 0.15%, preferably higher than 0.20%, preferably higher than 0.30%, preferably higher than 0.40%.

This element could allow increasing the mechanical strength of the alloy by solid solution and/or by dispersoids which might form during the manufacture of the part or during post-manufacture heat treatments. This element has a low solubility in aluminum. The addition of this element could allow hardening the alloy without having a significant impact on conductivity.

Cu and/or Ag:

According to the present invention, the elements Cu and/or Ag may be present in the aluminum alloy according to a mass fraction of 0.10 to 3.00%, preferably from 0.10 to 2.00%, preferably from 0.10 to 1.60%, preferably from 0.10 to 1.00%, preferably from 0.10 to 0.70% each and in total.

These elements could allow increasing the mechanical strength of the alloy by solid solution and/or by hardening precipitates which might form during the manufacture of the part or during post-manufacture heat treatments.

### Si:

According to the present invention, the element Si may be present in the aluminum alloy according to a mass fraction lower than 3.00%, preferably lower than 2.00%, preferably lower than 1.00%, preferably lower than 0.50%; in one embodiment, the Si content is lower than 0.30%, preferably lower than 0.20%. Preferably, the mass fraction of Si is higher than 500 ppm, preferably higher than 0.10%, preferably higher than 0.15%.

The addition of Si in the presence of Zr could lead to the formation of AlZrSi coarse phases which would limit the hardening power of Zr after heat treatment.

### Sc:

According to the present invention, the element Sc may be present in the aluminum alloy according to a mass fraction lower than 0.80%, preferably lower than 0.70%, preferably lower than 0.60%, preferably lower than 0.50%, preferably lower than 0.40%, preferably lower than 0.30%. Preferably, the mass fraction of Sc is higher than 500 ppm, preferably higher than 0.10%, preferably higher than 0.15%, preferably higher than 0.20%.

This element may have the same technical effects as the elements Zr, Hf and Er. On the other hand, according to a variant of the present invention, the Inventors have noticed that a good tradeoff between the mechanical properties and the conductivity could also be obtained, preferably after heat treatment, by replacing at least partially the group of elements Co, La, Ce, mischmetal, W, Ta, Mo and/or Nb with Sc, according to the mass fractions as described hereinbefore.

Mg, Zn and/or Li:

According to the present invention, the elements Mg, Zn and/or Li may be present in the aluminum alloy according to a mass fraction lower than 2.00%, preferably lower than 1.00%, preferably lower than 0.50%, more preferably lower than 0.30% each. Preferably, the mass fraction of Mg, Zn and/or Li is higher than 500 ppm, preferably higher than 0.10%, preferably higher than 0.15% each.

These elements could allow increasing the mechanical strength of the alloy by solid solution. However, these elements are sensitive to evaporation during the laser melting, which could lead to the formation of fumes and instabilities of the melt baths. The excessive addition of these elements could significantly lower the electrical conductivity. Thus, according to one embodiment, the addition of these elements should therefore preferably be avoided.

Nd, Y, Tm, Lu, Yb, Sr, Ba, Sb, Bi, Ca, P, B, In and/or Sn:

According to the present invention, at least one element selected from: Nd, Y, Tm, Lu, Yb, Sr, Ba, Sb, Bi, Ca, P, B, In and Sn may be present in the aluminum alloy according to a mass fraction lower than or equal to 1.00%, preferably lower than or equal to 0.50%, preferably lower than or equal to 0.30%, more preferably lower than or equal to 0.10%, even more preferably lower than or equal to 700 ppm each, and lower than or equal to 2.00%, preferably lower than or equal to 1.00%, preferably lower than or equal to 0.50%, preferably lower than or equal to 0.30% in total. Preferably, the mass fraction of Nd, Y, Tm, Lu, Yb, Sr, Ba, Sb, Bi, Ca, P, B, In and Sn is higher than 100 ppm, preferably higher than 300 ppm, preferably higher than 500 ppm each and in total.

These elements could allow increasing the mechanical strength of the alloy by solid solution and/or by dispersoids which might form during the manufacture of the part or during post-manufacture heat treatments. However, the excessive addition of these elements could degrade the conductivity of the alloy, it is for this reason that, according to one embodiment, their addition is preferably done according to a mass fraction lower than 700 ppm each.

It should be noted that, preferably, the alloys according to the present invention are not AA6xxx alloys, because of the absence of simultaneous addition of Si and Mg in amounts greater than 0.2%.

The method may include, following the formation of the layers, i.e. following the formation of the final part, applying at least one heat treatment. This treatment is also so-called post-manufacture or post-treatment heat treatment. The post-manufacture heat treatment may be or include tempering or annealing. It may also include a solution heat treatment and a quenching, even though it is preferred to avoid them. It may also include a hot isostatic pressing.

According to a first variant, in order to favor the mechanical properties, the post-manufacture heat treatment may be performed:
at a temperature T′ higher than 400 °C, in which case the duration of the post-manufacture heat treatment is comprised between 0.1 h and 50 h, preferably from 0.1 h to 10 h;
or at a temperature T′ comprised between 300 °C and 400 °C, in which case the duration of the post-manufacture heat treatment is comprised between 0.1 h and 200 h.

According to a second variant, in order to favor the thermal or electrical conduction properties, the post-manufacture heat treatment may be performed at a temperature T′ higher than or equal to 350 °C or 400 °C for a duration of 0.1 h to 200 h, so as to obtain an optimum thermal or electrical conductivity.

According to another variant, two-step post-manufacture heat treatments may allow maximizing the electrical conductivity. These treatments firstly consist of a first step at a temperature T′1 higher than 450 °C for a duration of 0.1 h to 100 h, followed by a second stage at a temperature T′2 comprised between 300 °C and 450 °C for a duration of 0.1 h to 200 h.

According to another variant, two-step post-manufacture heat treatments may allow maximizing the electrical conductivity and/or the hardness. These treatments firstly consist of a first step at a temperature T′1 lower than 380 °C for a duration of 0.1 h to 200 h, followed by a second step at a temperature T′2 comprised between 380 °C and 450 °C for a duration of 0.1 h to 200 h.

According to another variant, three-step post-manufacture heat treatments may allow maximizing the electrical conductivity and/or the hardness. These treatments firstly consist of a first step at a temperature T′1 comprised between 250 °C and 450 °C for a duration of 0.1 h to 200 h, followed by a second step at a temperature T′2 higher than 450 °C for a duration of 0.1 h to 100 h, followed by a third step at a temperature T′3 comprised between 250 °C and 450 °C for a duration of 0.1 h to 200 h.

Multi-step treatments with a number of steps greater than 3 may also be considered.

According to one embodiment, the method may include a hot isostatic pressing (HIP). In particular, the HIP treatment may allow improving the elongation properties and the fatigue properties. The hot isostatic pressing may be carried out before, after or instead of the post-manufacture heat treatment. Advantageously, the hot isostatic pressing is carried out at a temperature of 250 °C to 500 °C and preferably from 300 °C to 450 °C, at a pressure of 500 to 3,000 bar and for a duration of 0.5 to 100 hours.

According to an advantageous embodiment, the method does not include any quenching following the formation of the layers, i.e. following the formation of the final part, or following the post-manufacture heat treatment. Thus, preferably, the method includes no steps of solution heat treatment followed by quenching.

Resorting to a post-manufacture heat treatment, the manufacture being carried out by an additive manufacturing process, could allow creating expansion conditions allowing eliminating the residual stresses as well as a precipitation of hardening phases. We also talk about thermal expansion. The Inventors have observed that it was preferable for the setpoint temperature T′ of the post-manufacture heat treatment to be comprised between 300 °C and 500 °C.

In particular, the possible heat treatment and/or the hot isostatic pressing allows increasing the hardness or the yield strength and the electrical conductivity of the obtained product. However, it should be noted that, in general, the higher the temperature, the more the conductivity (electrical or thermal) is promoted to the detriment of the mechanical strengths.

According to an embodiment, besides the temperature T′ of the post-manufacture heat treatment, the rise in temperature, initiating the post-manufacture heat treatment, is preferably as fast as possible. For example, during the rise in temperature, the temperature rise rate ΔT′ (usually referred to by a person skilled in the art as “heating rate” in °C per minute or in °C per second) is preferably higher than 5 °C per minute or higher than 10 °C per minute, or more preferably higher than 20 °C per minute and more advantageously higher than 40 °C per minute, and more advantageously higher than 100 °C per minute. By “rise in temperature”, it should be understood the rise in temperature at which the part is subjected during the post-manufacture heat treatment. It seems to be optimum that the rise in temperature is instantaneous, i.e. the manufactured part is subjected, as of the start of the post-manufacture heat treatment, to the setpoint temperature T′ of the post-manufacture heat treatment. An instantaneous rise in temperature may be obtained by placing the manufactured part in a hot oven, already brought to the setpoint temperature T′, or by a rapid heating means of the fluidized bed or molten salt bath type. The rise in temperature may also be ensured by induction heating.

For the same rise in temperature outside the part, the variation of temperature inside the part depends in particular on the heating medium (liquid or air or inert gas) as well as on the shape of the part. In particular, the temperature across the thickness or at the surface of the part may be different. This is the reason why the aforementioned rise in temperature corresponds to the temperature outside the part. The combination of a preheating temperature T, a post-manufacture heat treatment T′ and a temperature rise rate ΔT′, during the temperature rise of the post-manufacture heat treatment, in the aforementioned ranges of values, allows obtaining parts having a good resistance to thermal cracking.

According to another embodiment, suitable for structural hardening alloys, it is possible to carry out a solution heat treatment followed by quenching and tempering of the formed part and/or a hot isostatic pressing. In this case, hot isostatic pressing may advantageously replace the solution heat treatment.

However, the process according to the invention is advantageous because it preferably does not require a treatment consisting in a solution heat treatment followed by quenching. The solution heat treatment may have a detrimental effect on the mechanical strength in some cases by contributing to a magnification of the dispersoids or of the fine intermetallic phases. Preferably, the method according to the present invention includes no solution heat treatment and/or quenching following the formation of the layers, i.e. following the formation of the final part, or following the post-manufacture heat treatment.

Preferably, the method according to the present invention is such that the part 20 has:
In the manufacturing raw state, an electrical conductivity higher than 6 MS/m, preferably higher than 7 MS/m, preferably higher than 8 MS/m; and
In the manufacturing raw state, a Knoop hardness HK0.05 lower than 140, preferably lower than 130, preferably lower than 120; and
After a post-treatment for 4 hours at 400 °C, a Knoop hardness HK0.05 higher than 70, preferably higher than 80, preferably higher than 90, preferably higher than 100, preferably higher than 114.

According to one embodiment, optionally, the method according to the present invention further includes a machining treatment, and/or a chemical, electrochemical or mechanical surface treatment, and/or a vibratory finishing. In particular, these treatments may be carried out to reduce the roughness and/or to improve the corrosion resistance and/or to improve the resistance to the initiation of fatigue cracks.

Optionally, it is possible to carry out a mechanical deformation of the part, for example after the additive manufacturing and/or before the heat treatment.

Although described in connection with an LPBF-type additive manufacturing method, the method may be applied to other WAAM (Wire plus Arc Additive Manufacturing) type additive manufacturing methods, mentioned in connection with the prior art. FIG. 2 shows such an alternative. An energy source 31, in this case a torch, forms an electric arc 32. In this device, the torch 31 is held by a welding robot 33. The part 20 to be manufactured is arranged on a support 10. In this example, the manufactured part is a wall extending according to a transverse axis Z perpendicular to a plane XY defined by the support 10. Under the effect of the electric arc 12, a filler wire 35 melts down to form a weld bead. The welding robot is controlled by a digital model M. It is moved so as to form different layers 20₁ . . . 20ₙ, stacked on top of one another, forming the wall 20, each layer corresponding to a weld bead. Each layer 20₁ . . . 20ₙ extends in the plane XY, according to a pattern defined by the digital model M.

Preferably, the diameter of the filler wire is smaller than 3 mm. It may be comprised between 0.5 mm and 3 mm and is preferably comprised between 0.5 mm and 2 mm, or from 1 mm to 2 mm. For example, it amounts to 1.2 mm.

Moreover, other methods may be considered, for example, and without limitation:
Selective Laser Sintering;
Direct Metal Laser Sintering;
Selective Heat Sintering;
Electron Beam Melting;
Laser Melting Deposition;
Direct Energy Deposition;
Direct Metal Deposition;
Direct Laser Deposition;
Laser Deposition Technology;
Laser Engineering Net Shaping;
Laser Cladding Technology;
Laser Freeform Manufacturing Technology;
Laser Metal Deposition;
Cold Spray Consolidation;
Additive Friction Stir;
Field Assisted Sintering Technology or spark plasma sintering; or
Inertia Rotary Friction Welding.

The solutions according to the present invention are particularly suitable for the cold spray process (so-called “cold spray”), in particular because of a low hardness of the powder, which facilitates the deposition. Afterwards, the part may be hardened by a hardening annealing (post-heat treatment).

The solutions according to the present invention are particularly suitable for applications in electric, electronic and heat exchanger industries.

The invention will be exposed in detail in the examples hereinafter, which are given for non-limiting illustrative purposes.

### EXPERIMENTAL EXAMPLES

### Example 1

The tested alloys have been cast in a copper mold using an Inducible VC 650V machine to obtain ingots with a height of 130 mm, a width of 95 mm and a thickness of 5 mm.

The alloys as described in Table 1 hereinafter have been tested by a rapid prototyping method. Samples have been machined for scanning the surface with a laser, in the form of strips with the dimensions 60×22×3 mm, from the ingots obtained hereinbefore. The strips have been placed in an LPBF machine and scans of the surface have been performed with a laser following the same scanning strategy and process conditions representative of those used for the LPBF process. Indeed, it has been found that, in this manner, it was possible to assess the ability of the alloys to the LPBF process and, in particular, the sensitivity to hot cracking, the hardness in the raw state and after heat treatment, the electrical conductivity in the raw state and after heat treatment.

Under the laser beam, the metal melts down in a bath with a thickness of about 500 μm. After passage of the laser, the metal cools down rapidly like in the LPBF process. After the laser scanning, a thin layer at the surface with a thickness of about 500 μm has been molten and then solidified. The properties of the metal in this layer are close to the properties of the metal at the core of a part manufactured by LPBF, because the scan parameters have been appropriately selected. The laser scanning of the surface of the different samples has been performed using a FormUP® 350 selective laser powder bed fusion (LPBF) machine supplied by AddUp. The laser source had a power of 400 W, the vector difference was 60 μm, the scanning speed was 500 mm/s and the diameter of the beam was 65 μm.

On each strip, two rectangular surfaces of 5 mm×35 mm each have been remelted for the hardness measurements and a rectangular surface of 15 mm×18 mm has been remelted for the measurement of the electrical conductivity.

FIG. 3 shows an example of a strip after laser reflow. The reference 1 corresponds to the two rectangular surfaces melted and used for the hardness measurement, the reference 2 corresponds to the remelted rectangular surface and used for the measurement of the electrical conductivity and the reference 3 corresponds to the non-remelted surface of the initial strip.

Following each test, a heat post-treatment has been applied on some samples. The heat treatment was of the annealing type, at a temperature of 400 °C, for 1 hour, or 4 hours, or 7 hours.

### Measurement of the Knoop Hardness

Hardness is a major property for alloys. Indeed, if the hardness in the layer remelted by scanning the surface with a laser is high, a part manufactured with the same alloy will have a high yield strength.

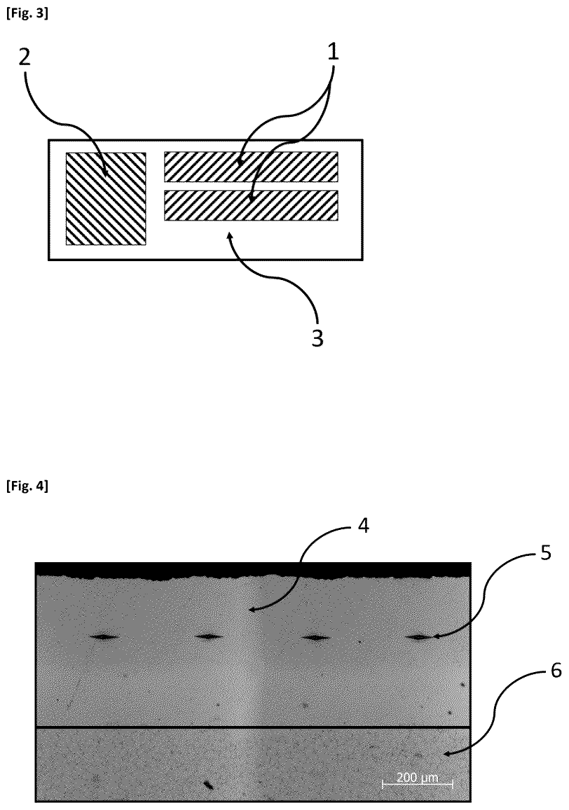

To assess the hardness of the remelted layer, the strips obtained hereinbefore have been cut in the plane perpendicular to the direction of the passes of the laser and have been polished afterwards. After polishing, hardness measurements have been performed in the remelted layer. The hardness measurement has been performed with a Durascan model apparatus supplied by Struers. The 50 g Knoop hardness method with the large diagonal of the impression placed parallel to the plane of the remelted layer has been selected to keep enough distance between the impression and the edge of the sample. 30 impressions have been positioned at mid-thickness of the remelted layer. FIG. 4 shows an example of the hardness measurement. The reference 4 corresponds to the remelted layer, the reference 5 corresponds to a Knoop hardness impression and the reference 6 corresponds to the non-remelted area.

The hardness has been measured according to the Knoop scale with a 50 g load after laser treatment (in the raw state) and after an additional heat treatment at 400 °C for variable durations, in particular allowing assessing the ability of the alloy to hardening during a heat treatment and the effect of a possible HIP treatment on the mechanical properties and the electrical conductivity.

### Measurement of the Electrical Conductivity

The remelted rectangular surface of 15 mm×18 mm of each strip has been subjected to electrical conductivity measurements, on the basis that the electrical conductivity evolves in a similar manner as the thermal conductivity. A linear dependence relationship between the thermal conductivity and the electrical conductivity, according to Wiedemann Franz law, has been validated in the publication by Hatch “Aluminum properties and physical metallurgy” ASM Metals Park, OH, 1988. The electrical conductivity measurements have been performed at the center of the remelted surface in the plane of the large face of the strips (plane parallel to the direction of the passes of the laser). The conductivity measurements have been performed in the raw state (without post-manufacture heat treatment) and after a heat treatment at 400 °C for variable durations of 1 hour, 4 hours or 7 hours. An average of 5 different measurements has been performed for each condition.

The conductivity measurements have been performed at a temperature of about 20 °C using a Foerster Sigmatest 2.069 type measurement apparatus at a frequency of 960 kHz. The choice of this frequency allows restricting the depth of measurement of the electrical conductivity at the remelted area of the strip.

The composition of the tested aluminum alloys is reported in Table 1 hereinafter, in weight percents.

A reference alloy has been used: the composition No. 1, which includes aluminum, as well as the following alloying elements: Fe (1.00%) and Zr (1.20%).

TABLE 1

| Composition | | | | | | | | |
|---|---|---|---|---|---|---|---|---|
| No. | Type | Fe | Zr | Mischmetal | Cr | Ti | Mn | V |
| 1 | Reference | 1.00 | 1.20 | | | | | |
| 2 | Invention | 1.00 | 1.20 | 2.50 | 2.00 | | | |
| 3 | Invention | 1.00 | 1.20 | 2.50 | 3.00 | | | |
| 4 | Invention | 2.00 | 1.20 | 2.50 | 3.00 | | | |
| 5 | Invention | 2.00 | 1.20 | 2.50 | | 1.00 | | |
| 6 | Invention | 1.00 | 1.20 | | | 1.00 | | |
| 7 | Invention | 2.00 | 1.20 | | | 2.00 | | |
| 8 | Invention | 1.00 | 1.20 | 2.50 | | | 1.00 | |
| 9 | Invention | 1.00 | 1.20 | 2.50 | | | 2.00 | |
| 10 | Invention | 2.00 | 1.20 | | | | 2.00 | |
| 11 | Invention | 1.00 | 1.20 | 2.50 | | | | 2.00 |
| 12 | Invention | 1.00 | 1.20 | | | | | 1.00 |

Table 2 hereinafter shows the Knoop hardness (HK0.05) and electrical conductivity measured values for each alloy, after laser reflow, in the raw state (0 hours of heat treatment).

TABLE 2

| | Heat | Knoop | Electrical |
|---|---|---|---|
| Composition | treatment at | hardness | conductivity |
| No. | 400 °C | (HK0.05) | (MS/m) |
| 1 | 0 h | 65.36 | 19.41 |
| 2 | 0 h | 94.98 | 10.98 |
| 3 | 0 h | 98.43 | 11.01 |
| 4 | 0 h | 118.94 | 9.82 |
| 5 | 0 h | 90.07 | 15.30 |
| 6 | 0 h | 77.18 | 12.71 |
| 7 | 0 h | 103.47 | 12.04 |
| 8 | 0 h | 79.76 | 11.22 |
| 9 | 0 h | 97.80 | 8.47 |
| 10 | 0 h | 95.29 | 8.45 |
| 11 | 0 h | 94.20 | 15.42 |
| 12 | 0 h | 70.36 | 11.59 |

Table 3 hereinafter shows the Knoop hardness (HK0.05) and electrical conductivity measured values for each alloy, after laser reflow, and after annealing at 400 °C, carried out after the laser reflow, for 1 hour.

TABLE 3

| | Heat | Knoop | Electrical |
|---|---|---|---|
| Composition | treatment at | hardness | conductivity |
| No. | 400 °C | (HK0.05) | (MS/m) |
| 1 | 1 h | 100.70 | 25.35 |
| 2 | 1 h | 124.94 | 12.94 |
| 3 | 1 h | 128.60 | 12.67 |
| 4 | 1 h | 146.38 | 11.79 |
| 5 | 1 h | 102.78 | 18.37 |
| 6 | 1 h | 104.56 | 16.19 |
| 7 | 1 h | 107.04 | 14.68 |
| 8 | 1 h | 121.21 | 14.40 |
| 9 | 1 h | 128.88 | 11.56 |
| 10 | 1 h | 122.38 | 12.74 |
| 11 | 1 h | 118.18 | 18.63 |
| 12 | 1 h | 106.39 | 13.23 |

Table 4 hereinafter shows the Knoop hardness (HK0.05) and electrical conductivity measured values for each alloy, after laser reflow, and after annealing at 400 °C, carried out after the laser reflow, for 4 hours.

TABLE 4

| | Heat | Knoop | Electrical |
|---|---|---|---|
| Composition | treatment at | hardness | conductivity |
| No. | 400 °C | (HK0.05) | in (MS/m) |
| 1 | 4 h | 113.32 | 28.64 |
| 2 | 4 h | 134.79 | 14.23 |
| 3 | 4 h | 136.06 | 13.42 |
| 4 | 4 h | 149.69 | 13.01 |
| 5 | 4 h | 120.26 | 21.02 |
| 6 | 4 h | 114.72 | 17.52 |
| 7 | 4 h | 121.84 | 16.31 |
| 8 | 4 h | 125.53 | 17.26 |
| 9 | 4 h | 134.13 | 14.64 |
| 10 | 4 h | 128.21 | 17.18 |
| 11 | 4 h | 128.12 | 21.57 |
| 12 | 4 h | 119.13 | 14.21 |

Table 5 hereinafter shows the Knoop hardness (HK0.05) and electrical conductivity measured values for each alloy, after laser reflow, and after annealing at 400 °C, carried out after the laser reflow, for 7 hours.

TABLE 5

| | Heat | Knoop | Electrical |
|---|---|---|---|
| Composition | treatment at | hardness | conductivity |
| No. | 400 °C | (HK0.05) | in (MS/m) |
| 1 | 7 h | 107.19 | 29.04 |
| 2 | 7 h | 134.03 | 14.46 |
| 3 | 7 h | 136.31 | 12.95 |
| 4 | 7 h | 148.59 | 12.34 |
| 5 | 7 h | 119.59 | 21.29 |
| 6 | 7 h | 108.82 | 18.71 |
| 7 | 7 h | 112.39 | 17.06 |
| 8 | 7 h | 121.47 | 18.50 |
| 9 | 7 h | 129.38 | 16.14 |
| 10 | 7 h | 119.50 | 18.96 |
| 11 | 7 h | 125.63 | 21.05 |
| 12 | 7 h | 116.71 | 15.61 |

The results of Tables 2, 3, 4 and 5 show that, for all of the tested solutions, the conductivity and hardness values were the lowest in the raw state. The additional heat treatment performed at 400 °C has allowed increasing both the electrical conductivity and the Knoop hardness (HK0.05) in comparison with the raw state.

For all of the tested solutions, the maximum conductivity has been obtained after 7 hours at 400 °C.

For all of the tested solutions, the maximum hardness has been obtained after a treatment at 400 °C between 1 hour and 7 hours. The duration allowing maximizing the hardness seems to be comprised between 0.5 hour and 10 hours for all of the tested solutions.

An increase in the duration of the heat treatment at 400 °C for durations longer than 10 hours would allow further increasing the thermal conductivity but would lower the hardness.

Thus, the final heat treatment may be selected according to the intended application.

As regards the alloys containing Sc, a heat treatment temperature comprised between 300 and 400 °C for a duration from 0.5 hour to 10 hours could be optimum to maximize hardness. For example, a temperature of 325 °C and a duration of 4 hours.

The reference alloy No. 1 has allowed obtaining the highest electrical conductivity for all of the tested conditions: in the raw state (without any post-manufacture heat treatment) and after a heat treatment at 400 °C for variables durations of 1 hour, 4 hours or 7 hours. The best Knoop hardness (HK0.05)/electrical conductivity (MS/m) tradeoff for this alloy has been obtained for a post-manufacture heat treatment for 4 hours at 400 °C with respective values of 113.32 HK0.05 for the hardness and 28.64 MS/m for the conductivity. This alloy is an excellent candidate for applications requiring a high thermal or electrical conductivity like heat exchangers, heat sinks, electronic cases, RF antennas, etc. However, the maximum hardness allowed by this alloy (113.32 HK0.05) remains insufficient for some applications that do not require particular performances in terms of electrical conductivity, but which require a high mechanical strength, like structural parts, hydraulic blocks, etc.

Tables 4 and 5 show that all of the alloys of the invention allow offering, after heat treatment, a Knoop hardness (HK0.05) higher than that of the reference alloy No. 1 with a maximum hardness of 149.69 HK0.05 obtained for the alloy No. 4 after a post-manufacture heat treatment for 4 hours at 400 °C.

All of the alloys of the invention could allow obtaining a good processability of the parts in the LPBF process as well as excellent mechanical performances of the parts in service. The good processability of the parts in the LPBF process may be obtained by combining in the manufacturing raw state, a sufficiently low hardness level (Knoop hardness HK0.05 in the manufacturing raw state lower than 140, preferably lower than 130, preferably lower than 120) and a sufficiently high thermal or electrical conductivity (electrical conductivity in the manufacturing raw state higher than 6 MS/m, preferably higher than 7 MS/m, preferably higher than 8 MS/m). This hardness and conductivity combination could allow limiting the level of residual stresses of the parts in the manufacturing raw state, which could significantly limit the risk of cracking, delamination or distortion, thereby significantly improving the processability of the parts in the LPBF process. The excellent mechanical performances of the parts in service could be obtained while maximizing the hardness of the parts after the post-manufacture heat treatment (Knoop hardness HK0.05 higher than 70, preferably higher than 80, preferably higher than 90, preferably higher than 100, preferably higher than 114 for example after 4 hours of heat treatment at 400 °C).

Table 1 shows that, unlike the reference alloy No. 1, all of the alloys of the invention had a total content of added elements higher than 3%.

1. A method for manufacturing an aluminum alloy part, said method comprising forming successive metal layers, superposed on top of one another, each layer being formed by deposition of a filler metal, the filler metal being subjected to an energy input so as to melt down and form, when solidifying, said layer, wherein the filler metal is an aluminum alloy including the following alloying elements (% by weight):
at least one alloying element selected from: Zr, Hf, and Er, according to a mass fraction higher than or equal to 0.30%, optionally from 0.30 to 2.50%, optionally from 0.40 to 2.00%, optionally from 0.40 to 1.80%, optionally from 0.50 to 1.60%, optionally from 0.60 to 1.50%, optionally from 0.70 to 1.40%, optionally from 0.80 to 1.30% each and in total;
at least one alloying element selected from Cr, V, Ti and Mn, according to a mass fraction higher than 0.50%, optionally from more than 0.50 to 6.00%, optionally from 1.00 to 5.00%, optionally 1.00 to 4.00%, optionally from 1.00 to 3.00%, each for V, Ti and Mn, and in total; and according to a mass fraction from more than 0.50 to 3.00% for Cr;
optionally at least one alloying element selected from: Co, La, Ce, mischmetal, W, Ta, Mo and Nb, according to a mass fraction of at least 0.10%, optionally at least 0.25%, optionally at least 0.50% each and in total; and according to a mass fraction lower than 5.00%, optionally lower than 4.00%, optionally lower than 3.00% each; and according to a mass fraction lower than 7.00%, optionally lower than 6.00%, optionally lower than 5, 00%, optionally lower than 4.00% in total;
Fe, according to a mass fraction of 0.10 to 2.50%, optionally from 0.15 to 2.50%, optionally from 0.20 to 2.50%, optionally from 0.30 to 2.50%, optionally from 0.50 to 2.50%, optionally from 0.75 to 2.25%;
optionally Ni, according to a mass fraction lower than 3.00%, optionally lower than 2.00%, optionally lower than 1.00%, optionally lower than 0.50%;
optionally at least one alloying element selected from: Cu and Ag, according to a mass fraction of 0.10 to 3.00%, optionally from 0.10 to 2.00%, optionally from 0.10 to 1.60%, optionally from 0.10 to 1.00%, optionally from 0.10 to 0.70% each and in total;
optionally Si, according to a mass fraction lower than 3.00%, optionally lower than 2.00%, optionally lower than 1.00%, optionally lower than 0.50%; optionally lower than 0.30%, optionally lower than 0.20%;
optionally Sc, according to a mass fraction lower than 0.80%, optionally lower than 0.70%, optionally lower than 0.60%, optionally lower than 0.50%, optionally lower than 0.40%, optionally lower than 0.30%;
optionally Mg, according to a mass fraction lower than 2.00%, optionally lower than 1.00%, optionally lower than 0.50%, optionally lower than 0.30%;
optionally Zn, according to a mass fraction lower than 2.00%, optionally lower than 1.00%, optionally lower than 0.50%, optionally lower than 0.30%;
optionally Li, according to a mass fraction lower than 2.00%, optionally lower than 1.00%, optionally lower than 0.50%, optionally lower than 0.30%;
optionally at least one element selected from: Nd, Y, Tm, Lu, Yb, Sr, Ba, Sb, Bi, Ca, P, B, In and Sn, according to a mass fraction lower than or equal to 1.00%, optionally lower than or equal to 0.50%, optionally lower than or equal to 0.30%, optionally lower than or equal to 0.10%, optionally lower than or equal to 700 ppm each, and lower than or equal to 2.00%, optionally lower than or equal to 1.00%, optionally lower than or equal to 0.50%, optionally lower than or equal to 0.30% in total;
impurities: <0.05% each, and <0.15% in total;
remainder being aluminum.

2. The method according to claim 1, wherein the aluminum alloy comprises at least one alloying element selected from: Co, La, Ce, mischmetal, W, Ta, Mo and Nb.

3. The method according to claim 1, wherein the mass fraction of aluminum is lower than 97%.

4. The method according to claim 1, wherein the part has:
In a manufacturing raw state, an electrical conductivity higher than 6 MS/m, optionally higher than 7 MS/m, optionally higher than 8 MS/m; and
In a manufacturing raw state, a Knoop hardness HK0.05 lower than 140, optionally lower than 130, optionally lower than 120; and
After a post-treatment for 4 hours at 400 °C, a Knoop hardness HK0.05 higher than 70, optionally higher than 80, optionally higher than 90, optionally higher than 100, optionally higher than 114.

5. The method according to claim 1, further comprising following formation of the layers, optionally following the formation of the final part, applying a post-manufacture heat treatment, optionally a tempering or an annealing.

6. The method according to claim 1, including no solution heat treatment and/or quenching following formation of the layers, optionally following formation of the final part, or following the post-manufacture heat treatment.

7. The method according to claim 1, wherein said method is carried out at a preheating temperature T ranging up to 500 °C.

8. The method according to claim 1, wherein the filler metal is in the form of a powder, exposure thereof to a beam of light or of charged particles results in a local meltdown followed by a solidification, so as to form a solid layer.

9. The method according to claim 1, wherein the filler metal originates from a filler wire, the exposure thereof to a heat source results in a local meltdown followed by a solidification, so as to form a solid layer.

10. A metal part obtained by a method of claim 1.

11. A powder, optionally intended to be used as a filler material of an additive manufacturing method, wherein said powder is formed by an aluminum alloy, including the following alloying elements (% by weight):
at least one alloying element selected from: Zr, Hf, and Er, according to a mass fraction higher than or equal to 0.30%, optionally from 0.30 to 2.50%, optionally from 0.40 to 2.00%, optionally from 0.40 to 1.80%, optionally from 0.50 to 1.60%, optionally from 0.60 to 1.50%, optionally from 0.70 to 1.40%, optionally from 0.80 to 1.30% each and in total;
at least one alloying element selected from Cr, V, Ti and Mn, according to a mass fraction higher than 0.50%, optionally from more than 0.50 to 6.00%, optionally from 1.00 to 5.00%, optionally from 1.00 to 4.00%, optionally from 1.00 to 3.00%, each for V, Ti and Mn, and in total; and according to a mass fraction from more than 0.50 to 3.00% for Cr;
optionally at least one alloying element selected from: Co, La, Ce, mischmetal, W, Ta, Mo and Nb, according to a mass fraction of at least 0.10%, optionally at least 0.25%, optionally at least 0.50% each and in total; and according to a mass fraction lower than 5.00%, optionally lower than 4.00%, optionally lower than 3.00% each; and according to a mass fraction lower than 7.00%, optionally lower than 6.00%, optionally lower than 5.00%, optionally lower than 4.00% in total;
Fe, according to a mass fraction of 0.10 to 2.50%, optionally from 0.15 to 2.50%, optionally from 0.20 to 2.50%, optionally from 0.30 to 2.50%, optionally from 0.50 to 2.50%, optionally from 0.75 to 2.25%;
optionally Ni, according to a mass fraction lower than 3.00%, optionally lower than 2.00%, optionally lower than 1.00%, optionally lower than 0.50%;
optionally at least one alloying element selected from: Cu and Ag, according to a mass fraction of 0.10 to 3.00%, optionally from 0.10 to 2.00%, optionally from 0.10 to 1.60%, optionally from 0.10 to 1.00%, optionally from 0.10 to 0.70% each and in total;
optionally Si, according to a mass fraction lower than 3.00%, optionally lower than 2.00%, optionally lower than 1.00%, optionally lower than 0.50%; optionally lower than 0.30%, optionally lower than 0.20%;
optionally Sc, according to a mass fraction lower than 0.80%, optionally lower than 0.70%, optionally lower than 0.60%, optionally lower than 0.50%, optionally lower than 0.40%, optionally lower than 0.30%;
optionally Mg, according to a mass fraction lower than 2.00%, optionally lower than 1.00%, optionally lower than 0.50%, optionally lower than 0.30%;
optionally Zn, according to a mass fraction lower than 2.00%, optionally lower than 1.00%, optionally lower than 0.50%, optionally lower than 0.30%;
optionally Li, according to a mass fraction lower than 2.00%, optionally lower than 1.00%, optionally lower than 0.50%, optionally lower than 0.30%;
optionally at least one element selected from: Nd, Y, Tm, Lu, Yb, Sr, Ba, Sb, Bi, Ca, P, B, In and Sn, according to a mass fraction lower than or equal to 1.00%, optionally lower than or equal to 0.50%, optionally lower than or equal to 0.30%, optionally lower than or equal to 0.10%, optionally lower than or equal to 700 ppm each, and lower than or equal to 2.00%, optionally lower than or equal to 1.00%, optionally lower than or equal to 0.50%, optionally lower than or equal to 0.30% in total;
impurities: <0.05% each, and <0.15% in total;
remainder being aluminum.

12. A product comprising a powder according to claim 11, adapted to be used in a manufacturing process selected from: electron beam melting, cold spray consolidation, laser metal deposition, additive friction stir, field-assisted sintering or inertia rotary friction welding, optionally cold spray consolidation.
